(19) United States
(12) Patent Application Publication
(10) Pub. No.: US 2007/0082320 A1
(43) Pub. Date: Apr. 12, 2007

(54) Angled implant prosthesis and method of use thereof

(76) Inventor: Vicente Gabriel Faus Badia, Valencia (ES)

Correspondence Address: KLAUBER & JACKSON, 411 HACKENSACK AVENUE, HACKENSACK, NJ, 07601, US

(21) Appl. No.: 11/442,654

(22) Filed: May 26, 2006

(30) Foreign Application Priority Data
Oct. 10, 2005 (ES) 200502461

(51) Int. Cl. A61C 8/00

(52) U.S. Cl. 433/173

(57) ABSTRACT

The prosthesis includes, initially, an implant and an angled abutment's stump that is affixed to the implant by threading devices, to which a dental prosthetic piece is then attached. The invention is characterized in that the threading means include a threaded lower piece (4) matched to the angled abutment's stump (6), in which the angled piece (4) and the abutment form one whole piece (5). In this manner unthreading the abutment piece is prevented and the prosthetic dental piece (8) abuts an adjacent dental piece since said unthreading action requires making eccentric circular motions. A special key that couples the angled abutment is intended to effect the turning motion required to tighten the abutment. In addition the invention entails two sets of abutments, each one comprising similar abutments that differ in a slight variation or offset at the beginning of the thread intended to achieve the desired tilt of the abutment.

### RELATED APPLICATION

The present application claims priority from Spanish Application Serial No. 200502461, filed Oct. 10, 2005. Applicants claim the benefits of 35 U.S.C. §119 as to said Spanish application, and the entire disclosure of the application is incorporated herein by reference in its entirety.

### FIELD OF THE INVENTION

This invention refers, as expressed in the title of this descriptive narrative, to an angled implant prosthesis configured in one piece and the method of use thereof.

Basically, the prosthesis comprises generally an implant attached to the bone of the patient's mandible and an abutment's stump, or angled pillar, or prosthetic implant also attached to the implant, to which the corresponding and matching dental piece will be attached.

Understanding this as a basic premise, the main objective of this invention is to obtain an angled abutment configured in one piece to avoid loosening through time of the through screw of the traditional prosthetic implants.

Another objective of the invention is to attain, by specific means, the desired tilt angle and plane of the abutment in relation to the dental piece in question.

A third objective of the invention is focussed on the method of affixing the angled abutment or implant system, which is achieved by a special tool or key.

### BACKGROUND OF THE INVENTION

Implant systems usually entail two types of pillars o prosthetic abutments' stumps to configure the fixed cemented prosthesis:
Straight abutments
Angled abutments

There are, generally, two types of straight abutments, those configured in one piece or those configured as a two parts piece. One piece abutments have the threaded portion and the emergent or prosthetic piece joined forming one piece.

Two piece abutments have a hexagon or an octagon inside the implant that fits the hexagonal platform placed in the lower side of the emergent piece and thus prevents the emergent piece from gyrating. This piece is hollow throughout and is internally traversed by a screw that affixes it to the implant (through screw).

Angled abutments are only manufactured in two pieces and follow the same principle as the two piece pillars.

There is a great diversity of hexagonal head screwdrivers which function is to screw the angled or straight portion to the implant.

On the other hand, an abutment, whether straight o angled, in two pieces will be screwed in a central position by means of the described through screw that is affixed in a central manner, which implies it is easy to use. However, with the passing of time and due to the action of grease, the through screw begins to loosen. Vibration caused by mastication forces and the fat contained in foodstuffs that filters through the joint between the implant and the false prosthetic abutment or prosthetic pillar o prosthetic implant also influence the loosening of the screw.

Another disadvantage of this system is that, although fitting the hexagon of the false prosthetic abutment to the implant outside the patient's mouth is easy, it becomes difficult when the implant is already set in place in the bone and under the gum, since soft tissue gets in the way and the slightest interposition of tissue makes for an imperfect fit, obstructing the passage of the through screw, which creates subsequent problems such as the loosening and fracture of the Titanium.

### SUMMARY OF THE INVENTION

To attain the stated objectives and avoid the disadvantages mentioned in the above paragraphs, this invention proposes an angled abutment characterized in that it has its own means of attachment to an implant, placed in the mandible's bone of a patient, that can then receive the appropriate dental piece.

A second characteristic of the invention is the specific means to orient the abutment's tilt in the desired radial plane according to the placement of the implant in the maxillary bone inside the patient's mouth.

Said plane coincides with the definitive position of the prosthetic abutment, in such a manner that the abutment has a lower portion that is threaded so it can be coupled with the also threaded complementary orifice, of the implant. Therefore, both the tilting of the upper part of the prosthetic abutment and the threaded lower portion will be contained in said radial plane. The abutment's stump includes a short base perpendicular to the threaded portion, from which said threaded portion arises.

The method of use is characterized in that it incorporates a special key that adapts to the tilt of the abutment counteracting it, and above its base, in such a manner that the key is arranged in the same direction of the lower threaded part or in a parallel direction close to the direction of said lower portion.

In order to achieve this, the key is characterized in that it has a tubular section provided with a lateral window through which part of the tilted abutment peeks out. The upper part of the key above the lateral window presents a structure that allows manual handling or handling with a tool, to make the twisting or turning manoeuvre easier when tightening the abutment during the threading step that affixes it to the implant.

The method of use is characterized in that the orientation of the prosthetic abutment depends on the structure of the lower threaded portion of said prosthetic abutment.

The method is based on a set of prosthetic abutments in which the starting point of the thread is slightly different for each of them, which serves to attain a different threading angle for each that facilitates achieving the desired orientation or tilt of the prosthetic abutment's stump or pillar.

This variation spans one round of the initial thread section of the lower abutment section. The desired orientation can also be achieved by varying the length of the lower portion in very minute values.

The method of use of the invention is complemented with a similar additional implant. The first implant is inserted in the maxillary bone of the patient and another similar additional implant that is not inserted in the bone serves as trial sample to try out and ensure the correct orientation of the abutment before it is coupled to the definitive implant inserted in the patient's maxillary bone.

The drawings below will serve to better understand the invention and method of use thereof. These drawings, that are an integrated part of the present document, are to be understood as illustrative but not limiting of the scope of the invention.

### BRIEF DESCRIPTION OF THE DRAWINGS

FIG. 1 Shows an exploded view of an angled prosthetic implant and method of use thereof, which is the objective of this invention.

FIG. 2 Shows a view of the application of the prosthesis object of the invention.

FIG. 3 Shows a view of a compartmentalized box housing a set of angled abutments. This box is part of the invention.

FIG. 4 Shows a perspective view of a special key that is also part of the invention.

FIG. 5 Shows a view of a prosthetic implant tightened with a traditional key.

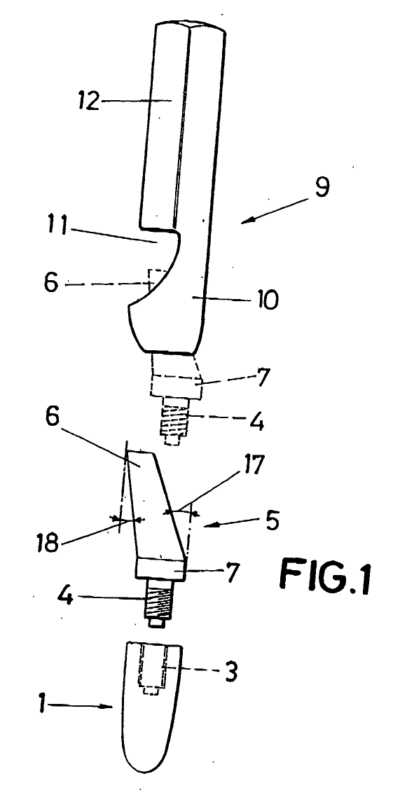

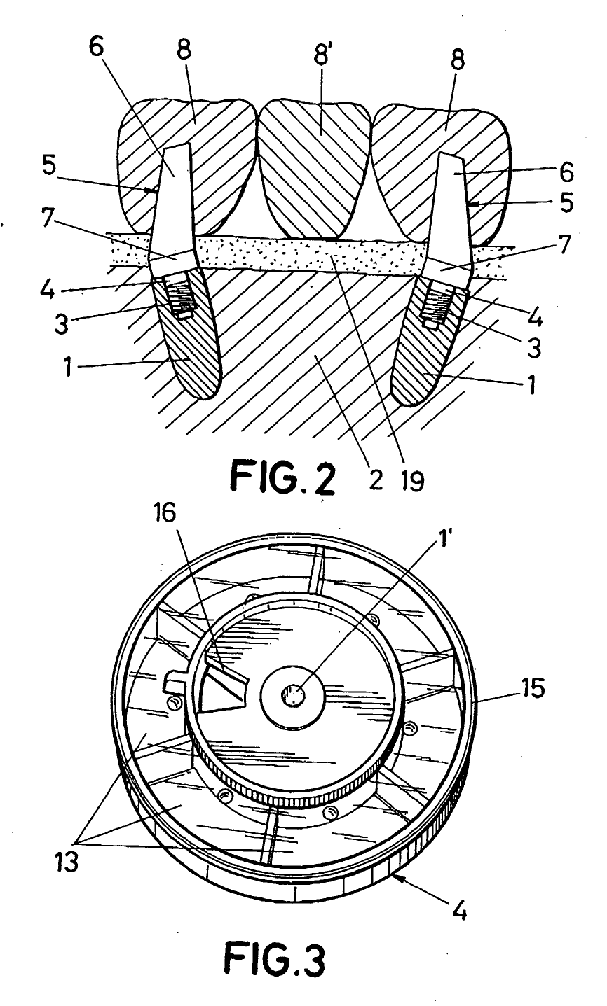

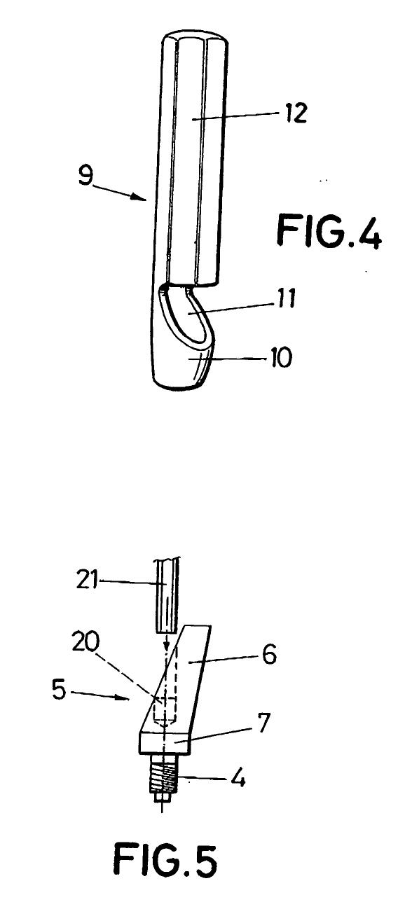

### DESCRIPTION OF THE PREFERRED EMBODIMENT

Using the same number codes as those that appear in the Figures, the angled prosthetic implant is defined by an implant 1 affixed to the mandible 2 of a patient's bone, where said implant 1 has a threaded orifice 3 to which is coupled a lower threaded section 4 that is part of a mono-piece angled abutment 5 with a tilted stump portion 6 having a truncated cone structure that rises out of a short intermediate cylindrical section 7 and from which its free base starts said threaded portion 4.

The required dental piece 8 will be affixed over said prosthetic abutment's stump 6.

Coupling and affixing of the abutment 5 is done, first, by a special key 9 that has, at the least, one tubular lower portion 10 provided with a lateral window 11 and an hexagonal, or any other geometrical configuration, cross-section upper portion 12 which function is to aid the handling of said key 9 so it can be turned to thread the abutment 5 onto the appropriate implant 1.

To do this, the tilted abutment's stump 6 is inserted first in the inner space of the lower tubular portion 10 of key 9 until it peeks out of the lateral window 11, at which point, key 9will be placed pointing in the same direction than the lower threaded portion 4 and acting as a continuation of said portion. Once in this position, the procedure can continue by coupling and affixing the angled abutment 5, threading it by turning the key 9, which motion will obviously drag with it the abutment 5.

To obtain the desired angle or tilt of abutment 5 in relation to the axis of rotation of its threaded portion 4, the starting point of the threading of this portion will vary in a 360° angular space in as many partial angle portions as desired by the manufacturer or the designer.

Another manner to obtain the desired tilt could be to increase or decrease the height of the short intermediate cylindrical portion 7 using as reference point its lower base, from which threaded portion 4 arises.

The prosthesis featured by this invention presents, amongst others, one first advantage by having a structure of greater solidity achieved by the angled abutment being in one piece, and a second advantage that resides in that the abutment is affixed by threading it with a rotational motion, and therefore it will never be badly installed, even when soft gum tissue 19 gets in the way, since the threading motion serves to remove the tissue from the gum as it progresses.

The special key 9 threads the angled abutment 5 in a centrally oriented manner when the abutment is already set in place inside the tubular portion 10 of key 9 and peeking out lateral window 11

This fitting of the abutment and the key absorbs the angulation retaining it in place inside the key so placement is not lost during the time prior to actual installation, which is the most delicate stage of the procedure, since the piece could fall inside the patient's mouth cavity causing the expected problems.

Once the prosthesis set is assembled its immobilization is ensured by the mono-piece abutment structure that includes the tilted stump 6 of the abutment and the threaded portion 4, in such a manner that the dental piece will abut tangentially against an adjacent dental piece 8′ to prevent its unthreading.

The tilted stump presents a truncated conical cross section that when relating it to the plane of the direction of the stump creates a first major angle 17 between and axial line of the stump and a perpendicular line parallel to the threaded potion, containing said line and said axial line within the plane.

A second minor angle 18 is also generated between a second axial line contained in said plane and another perpendicular line such as the one mentioned in the previous paragraph.

In order to encompass any desired angle position of the abutments, the invention includes sets of like abutments which final rotating angular variation after being tightened is, for instance, 12°, 15°, 30°, 60°, or any other value. The last one resembles a hexagon.

This set of abutments will be located in independent compartments 13 of a box 14 provided with a transparent and rotating lid 15 with a through hole 16 that allows the selection and extraction of the desired abutment.

To this effect every compartment will contain a group of prosthetic abutments of a specific angular variation.

Also, in the centre of box 14 there is a coupling base acting as fixed implant 1′ to be used as reference and control check for the selected prosthetic abutment.

The prosthetic abutment's stump 6 can incorporate a cavity 20 with any given section different from the circular section that will fit the appropriate tightening key 21.

The invention has been described in an illustrative manner, and it is to be understood that the terminology, which has been used is intended to be in the nature of words of description rather than of limitation.

While the present invention has been set forth in terms of a specific embodiment or embodiments, it will be understood that the equipment herein disclosed may be modified or altered by those skilled in the art to other configurations, and that the invention includes variations in form, size, parts and details of operation within its scope. Accordingly, the invention is to be broadly construed and limited only by the scope and spirit of the claims appended hereto.

All publications, including but not limited to patents and patent applications, cited in this specification are herein incorporated by reference as if each individual publication were specifically and individually indicated to be incorporated by reference herein as though fully set forth.

1. IMPLANT PROSTHESIS, that includes an implant located in the patient's mandible, as well as an angled abutment stump that is affixed to the implant by threading means, while in said abutment stump a prosthetic dental piece is affixed, wherein the threading means comprise a lower threaded portion (4) that couples with the matching tilted abutment stump (6) and together the abutment stump (6) and the threaded portion (4) constitute one piece (5), being so structured to prevent the unthreading of the one-piece abutment, and the prosthetic dental piece (8) abutting an adjacent dental piece (8′), since the unthreading action requires an eccentric circular motion.

2. IMPLANT PROSTHESIS, according to claim 1 wherein the abutment's stub comprises a truncated cone structure arising from a threaded cylindrical portion (7) from which free base arises the threaded portion (4).

3. IMPLANT PROSTHESIS, according to claim 1 wherein the angled abutment's stub (6) with a truncated cone structure includes two opposing axial lines with different tilt angles contained within the same plane as that of the direction of the threaded portion (4), a larger external angle (17), and a smaller inner angle (18).

4. METHOD TO USE AN ANGLED PROSTHESIS, according to claim 1, wherein it encompasses sets of like prosthetic abutments that are different from the abutments of the same set in that each has a small angular offset at the beginning of the thread of the lower portion (4) that enables the attainment of different tilts of the abutment's stump (6), allowing the selection of the most appropriate one.

5. METHOD OF USE OF AN ANGLED PROSTHESIS, according to claim 4, wherein each set of abutments is complemented by a box (14) with independent compartments (13) containing the abutments ordered according to angular offset, and the box (14) is further provided with a rotating lid (15) in which there is a through hole (16) to extract the selected abutment, the box in addition has a central coupling base acting as a fixed secondary abutment (1′) similar to the implant carried by the patient that serves to try out the position of the selected prosthetic abutment before insertion.

6. METHOD TO USE AN ANGLED PROSTHESIS, according to claim 1, wherein said prosthesis comprises a straight key (9) to turn and tighten the tilted abutment (5), and that the key (9) has a lower tubular portion (10) fitted with a lateral window (11) through which a portion of the tilted abutment's stump (6) peeks out after having inserted it through the opening of the lower tubular portion (10) of key (9), which results in key (9) being oriented in the same direction as that of the threaded portion (4) of the abutment above the key; all of it done to facilitate the turning and tightening of the abutment.

7. METHOD TO USE ANGLED ANGLED PROSTHESIS, according to claim 1, wherein the tilted abutment's stump (6) has a cavity (20) with a section different from the circular section that is complemented by the appropriate tightening key (21).
